(19) United States
(12) Patent Application Publication
(10) Pub. No.: US 2004/0250811 A1
(43) Pub. Date: Dec. 16, 2004

(54) Deep fat fryer burner tube insert for enhanced heat transfer

(76) Inventors: Donald W. Moravec, Oak Park, IL (US); Joseph V. Moravec, Downers Grove, IL (US)

Correspondence Address: Nicholas A. Camasto Ltd, 545 Thatcher, River Forest, IL, 60305, US

(21) Appl. No.: 10/457,855

(22) Filed: Jun. 10, 2003

(51) Int. Cl. A47J 37/12

(52) U.S. Cl. 126/390.1; 99/403

(57) ABSTRACT

A deep fat fryer burner tube insert for improving heat transfer and efficiency. The insert is stamped and formed from thin stainless steel having a length and a width that substantially equals the length and long dimension the oval cross section of a burner tube, respectively. Pairs of triangular-shaped fins are cut and oppositely bent outwardly perpendicular to the plane of the sheet for disrupting the laminar flow of combustion products through the burner tube. The number of triangular-shaped fins and their shape is selected to accommodate the needs of combustion efficiency and exhaust pollutant minimization. Right triangle-shaped fins having angles of 45° and 60° have been found effictive for use with burner tubes of 14 inch and 18 inch lengths, respectively.

### BACKGROUND OF THE INVENTION AND PRIOR ART

This invention relates in general to commercial deep fat fryers and in particular to a novel burner tube insert for enhancing heat transfer and combustion efficiency.

Commercial deep fat frying equipment for cooking foodstuffs, such as french fries, chicken, and the like, generally uses gas as the heat source. In such equipment, a number of gas burners cooperate with burner tubes that are situated in a cooking vessel, or fry pot, that is filled with cooking oil. The combustion products pass through and heat the burner tubes and are exhausted to the atmosphere by a flue. In an effort to enhance the heat transfer from the combustion products to the burner tube (and thence to the cooking oil) the prior art has used metal inserts in the burner tubes to help absorb more heat from the cumbustion products. The inserts used in the prior art deep fat fryer of FIGS. 1 and 2 had failed to achieve 50% efficiency, as determined by the standard water boil test, in which the total BTU input of the gas consumed is compared with the with the energy required to bring a given quantity of water to boiling temperature.

The present invention discloses a novel metal insert for use in the burner tube of a conventional deep fat fryer for improving the heat transfer and the efficiency of the fryer.

### OBJECTS OF THE INVENTION

A principal object of the invention is to provide an improved deep fat fryer.

A further object of the invention is to provide a deep fat fryer with enhanced burner tube heat transfer.

A further object of the invention is to provide a deep fat fryer of improved efficiency.

### BRIEF DESCRIPTION OF THE DRAWINGS

These and other objects and advantages of the invention will become apparent upon reading the following description in conjunction with the drawings, in which:

FIG. 1 is a simplified partial side view of a prior art deep fat fryer and burner tube insert;

FIG. 2 is an exploded partial perspective of the gas burner, fry pot, insert and flue shown in FIG. 1;

FIG. 3 is a partial perspective showing the insert of the invention in position in a burner tube;

FIG. 4 shows the insert of FIG. 3 prior to forming of the triangular-shaped fins;

FIGS. 5, 6 and 7 are side elevation, end and bottom views, respectively, of the formed insert of FIG. 4;

FIG. 8 shows another embodiment of the insert of the invention prior to forming of the triangular-shaped fins; and

FIG. 9 illustrates a bottom elevation of FIG. 8 after forming the triangular-shaped fins.

### DESCRIPTION OF THE PREFERRED EMBODIMENT

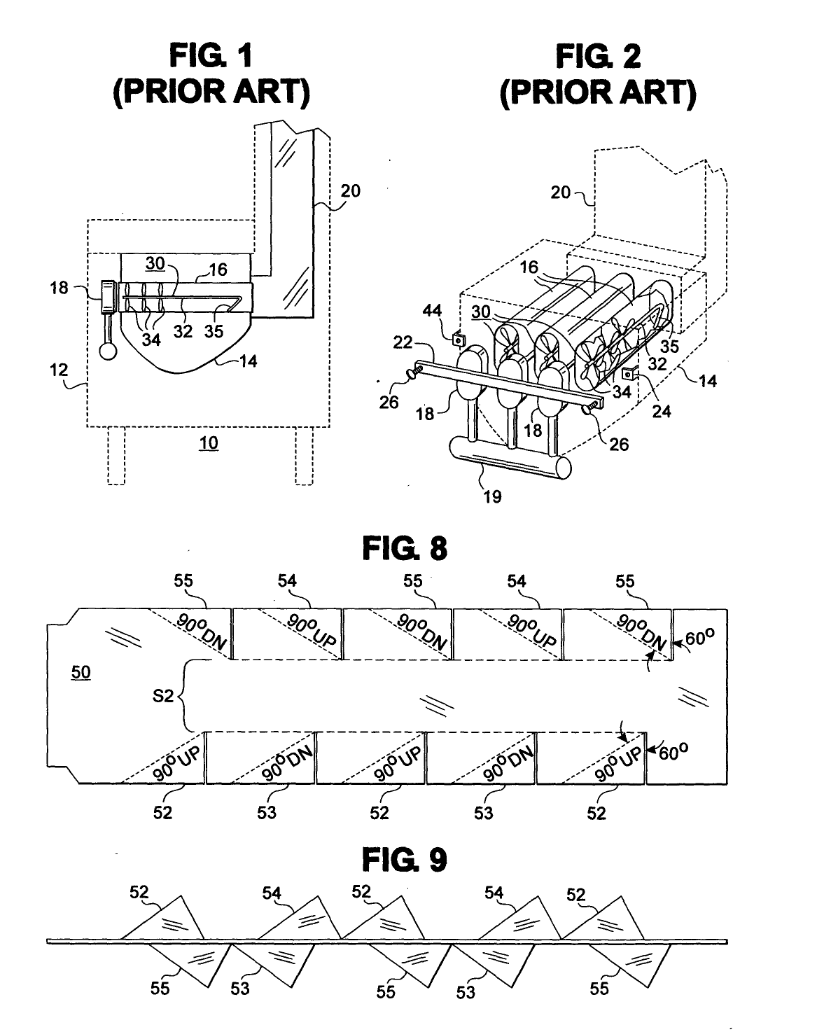

The prior art depictions of FIGS. 1 and 2 show, in simplified form, the basic configuration of a three-burner tube deep fat fryer 10. A cabinet 12 houses a fry pot 14 that includes three tubular burner tubes 16 and three corresponding gas burners 18. Burner tubes 16 have a generally oval-shaped cross section. Flame from a gas burner 18 passes through its respective burner tube 16 and combustion products exit from a common flue 20 that is shared by all of the burner tubes. The gas burners 18 are supplied from a gas manifold 19 and maintained in fixed relationship to burner tubes 16 by a support bar 22 that may be secured by screws 26, or the like, to suitable brackets 24 that are affixed to fry pot 14. The structure should be understood to be representative of deep fat fryers, which vary in capacity, number of burners and length of burner tubes. In accordance with the prior art, an insert 30 is placed in each of the burner tubes 16 to help absorb heat from the cumbustion products flowing in the burner tubes. As best seen in the partially broken away view of the end one of burner tubes 16, each insert 30 includes a metal spine 32 from which extends three metal blade clusters 34. The insert 30 is sized to fit within the confines of burner tube 16 and the end of spine 32 is bent, to form a leg 35, to help support the insert in the burner tube.

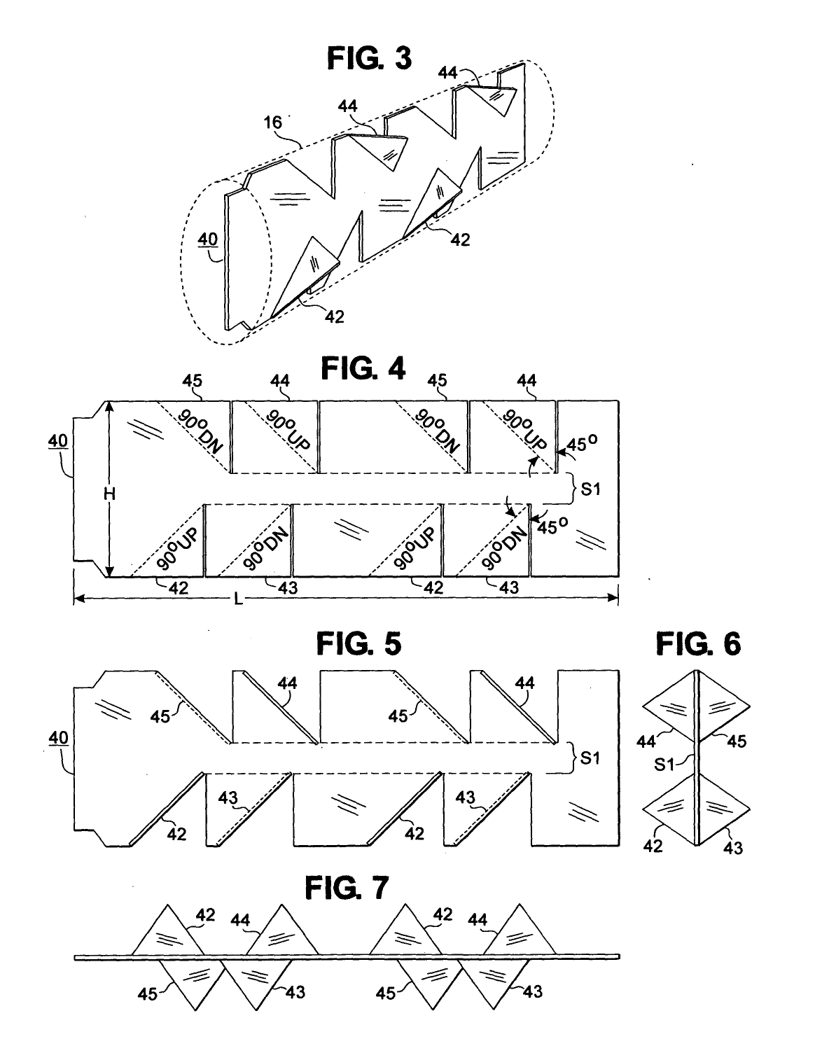

FIGS. 3-7 illustrate one embodiment of a novel insert, constructed in accordance with the invention, for a deep fat fryer burner tube. The perspective of FIG. 3 shows insert 40 of the invention installed in a burner tube 16 (in dashed lines). The insert 40 is formed from a rectangular, thin stainless steel sheet having an H dimension that matches the height or long dimension of the oval cross section of burner tube 16 and an L dimension that approximates the length of burner tube 16. Thus insert 40 may be readily positioned in and supported by burner tube 16. Insert 40 is cut to form a central spine S1 (indicated in dashed lines) and a plurality of rectangular-shaped tabs that are bent, as indicated, to form the pluralities of triangular-shaped fins 42, 43, 44, and 45 that extend on opposite sides of, and perpendicular to, spine S1. FIG. 4 indicates the direction of bending of the tabs of insert 40 to form the right triangle-shaped fins 42-45 and the 45° angle at which these bends are made. As best can be visualized in FIGS. 6 and 7, the oppositely extending triangular-shaped fins 42-45 disrupt the laminar flow of combustion products through burner tube 16, to enhance the absorption of heat therefrom while minimally restricting the flow of combustion products therethrough. Using the insert of the invention in a 14 inch long burner tube with an oval cross section of approximately three inches by five inches resulted in the heat transfer efficiency reaching the desired 50% figure, which was not attainable with the prior art insert arrangement shown in FIG. 2.

The inventive insert is adaptable to different sized burner tubes. In FIGS. 8 and 9, an insert 50 having a spine S2 is shown for an 18 inch long burner tube with approximately the same three inch by five inch oval cross section. In this version of the invention, the triangular-shaped fins are formed by bending at an angle of 60°, thus producing a less disruptive profile. The less disruptive profile of insert 50 is provided to accommodate the longer path of the combustion products, since combustion efficiency must also be correlated with completeness of combustion in order to minimize the pollutants that are discharged to the atmosphere. The 45° and 60° angles in the burner unit configurations shown have satisfied all combustion requirements and achieved 50% efficiency for the burner tube sizes described.

What has been described is a novel burner tube insert for a deep fat fryer. It is recognized that numerous changes to the described embodiment of the invention will be apparent to those skilled in the art without departing from its true spirit and scope. The invention is to be limited only as defined in the claims.

1. A deep fat fryer comprising:
a fry pot for holding a cooking medium;
a burner tube in said fry pot, said burner tube being substantially surrounded by said cooking medium;
a combustion burner supplying combustion products to said burner tube;
a flue for receiving and venting said combustion products from said burner tube; and
an insert in said burner tube for enhancing heat transfer and combustion efficiency, said insert extending substantially the full length of said burner tube and having a center spine supporting two rows of outwardly and oppositely directed triangular-shaped fins.

2. The fryer of claim 1, wherein said burner tube has a substantially oval cross section and wherein said insert is formed from a stainless steel plate having a length and a width that substantially equals the length of said burner tube and the long dimension of said oval cross section, respectively.

3. The fryer of claim 2, wherein said triangular-shaped fins are staggered along the length of said spine.

4. The fryer of claim 3, wherein said triangular-shaped fins are formed by slotting said plate to form a series of rectangular tabs and bending the tabs along substantial diagonals at 45° to said spine.

5. The fryer of claim 3, wherein said triangular-shaped fins are formed by slotting said plate to form a series of rectangular tabs and bending the tabs along substantial diagonals at 60° to said spine.

6. In combination in a deep fat fryer:
a fry pot for holding a cooking medium;
a burner tube in said fry pot, said burner tube having an oval cross section and being substantially surrounded by said cooking medium;
a combustion burner supplying combustion products to said burner tube;
a flue for receiving and venting said combustion products from said burner tube;
an insert in said burner tube for enhancing heat transfer and combustion efficiency, said insert being formed from a stainless steel plate having a length and a width that substantially equals the length of said burner tube and the long dimension of said oval cross section, respectively; and
said insert having a center spine supporting two rows of outwardly and oppositely directed triangular-shaped fins that are staggered along the length of said spine.

7. The fryer of claim 6, wherein said triangular-shaped fins are formed by slotting said plate to form a series of rectangular tabs and bending the tabs along substantial diagonals at 45° to said spine.

8. The fryer of claim 6, wherein said triangular-shaped fins are formed by slotting said plate to form a series of rectangular tabs and bending the tabs along substantial diagonals at 60° to said spine.
